(19) United States
(12) Patent Application Publication
(10) Pub. No.: US 2013/0262447 A1
(43) Pub. Date: Oct. 3, 2013

(54) METHOD AND SYSTEM TO PROVIDE INLINE REFINEMENT OF ON-LINE SEARCHES

(71) Applicants: Matthew Bret MacLaurin, Santa Cruz, CA (US); Jai Dandekar, San Jose, CA (US); Bhanu Koppaka, San Jose, CA (US); John Sheeley, San Francisco, CA (US); Naren Chittar, San Jose, CA (US); Govind Kaushal, San Jose, CA (US)

(72) Inventors: Matthew Bret MacLaurin, Santa Cruz, CA (US); Jai Dandekar, San Jose, CA (US); Bhanu Koppaka, San Jose, CA (US); John Sheeley, San Francisco, CA (US); Naren Chittar, San Jose, CA (US); Govind Kaushal, San Jose, CA (US)

(73) Assignee: eBay Inc., San Jose, CA (US)

(21) Appl. No.: 13/725,135

(22) Filed: Dec. 21, 2012

Related U.S. Application Data
(60) Provisional application No. 61/618,088, filed on Mar. 30, 2012.

(51) Int. Cl. G06F 17/30

(52) U.S. Cl. CPC G06F 17/30867
USPC 707/722

(57) ABSTRACT

Method and system to provide in-line refinement of online searches is described. The system may include a listing access module, an attribute selector, a filter control generator, and a presentation module. The listing access module may be configured to access a listing submitted to an on-line trading platform. The attribute selector may be configured to select an attribute in the listing. The filter control generator module may be configured to link the attribute to a search filter. The presentation module may be configured to present the attribute in the listing as a filler control in a presentation of the listing.

### TECHNICAL FIELD

This application relates to a method and system to provide in-line refinement of on-line searches.

### BACKGROUND

An on-line trading platform allows users to shop for almost anything using a web browser application. A user may find an item listed by an on-line trading application by entering keywords into the search box provided on an associated web page or by browsing through the list of categories on the home page. After a list of search results is returned, a user may further refine a search using a list of filters provided in the right-side portion of the search results web page. A user may select an item from the search results to view the details of the item. A user may then return to the search results page to further refine the search by using filters provided in the right-side portion of the search results web page.

Embodiments of the present invention are illustrated by way of example and not limitation in the figures of the accompanying drawings, in which like reference numbers indicate similar elements and in which:

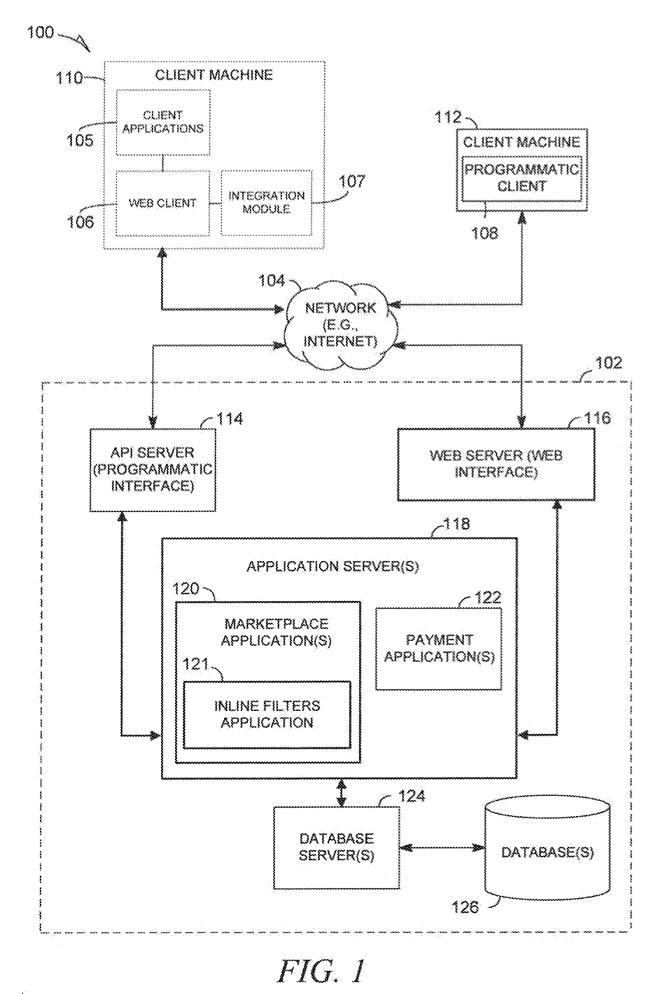

FIG. 1 is a network diagram depicting a client-server system, within which one example embodiment may be deployed;

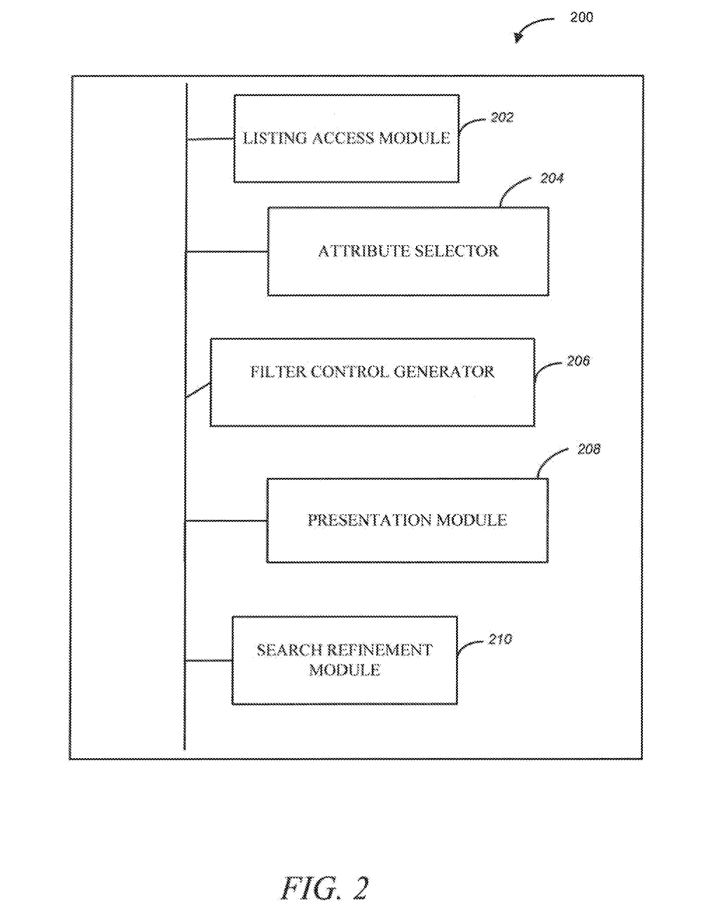

FIG. 2 is a block diagram of a system to provide in-line refinement of on-line searches, in accordance with one example embodiment;

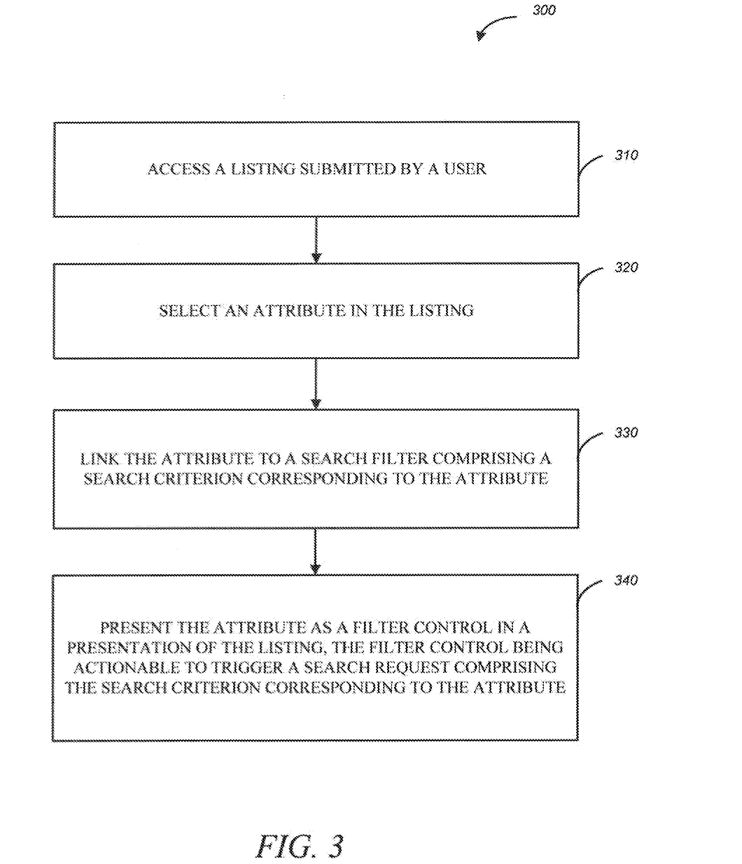

FIG. 3 is a flow chart of a method to provide in-line refinement of on-line searches, in accordance with an example embodiment;

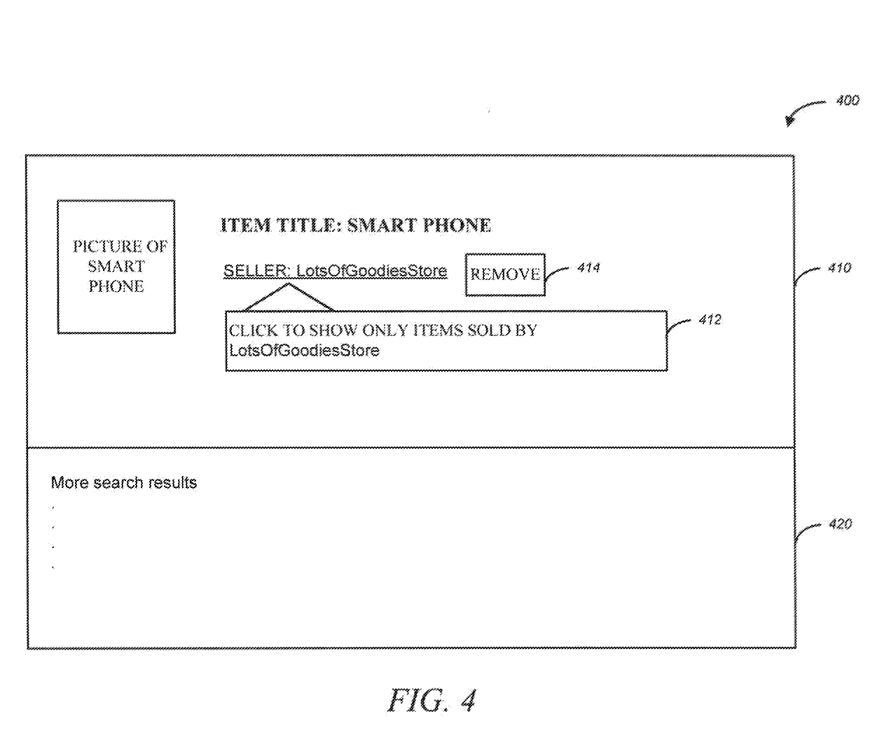

FIG. 4 shows an example presentation of a listing comprising a filter control, in accordance with an example embodiment; and

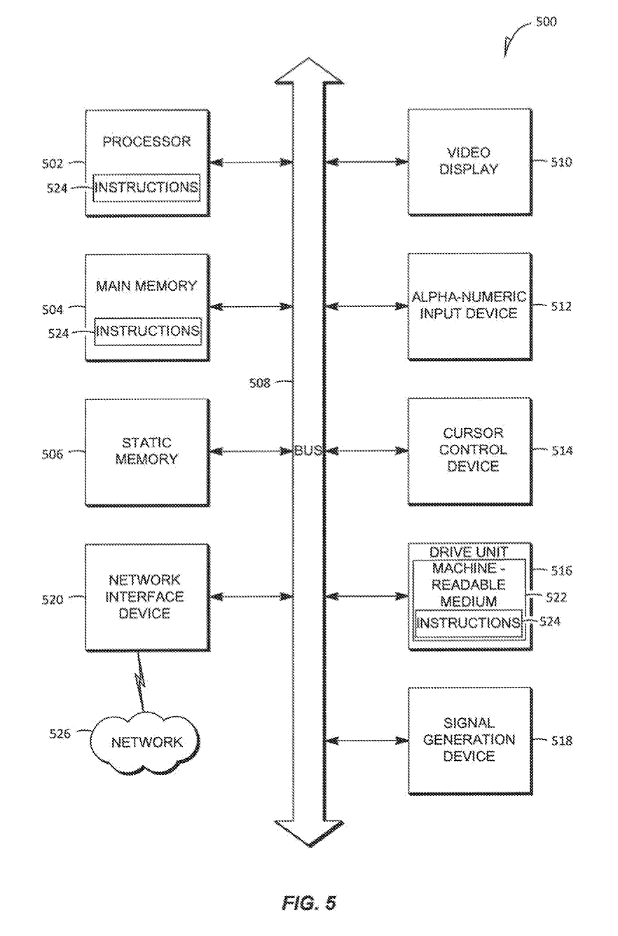

FIG. 5 is a diagrammatic representation of an example machine in the form of a computer system within which a set of instructions, for causing the machine to perform any one or more of the methodologies discussed herein, may be executed.

### DETAILED DESCRIPTION

A method and system to provide in-line refinement of on-line searches is described. In the following description, for purposes of explanation, numerous specific details are set forth in order to provide a thorough understanding of an embodiment of the present invention. It will be evident, however, to one skilled in the art that the present invention may be practiced without these specific details.

Embodiments of the present invention include approaches that enhance users experience by permitting a user to refine search results by activating search controls provided within the item listing presentation. For example, a listing may include information identifying a seller of the listed item. A system to provide in-line refinement of on-line searches may modify the listing to present the seller's name in the listing as an actionable control, a so-called filter control. When such modified listing is presented as part of the search results and a user clicks or otherwise activates the filter control associated with the seller's name, the search results are further refined to include only those listings that are from that seller. A system to provide in-line refinement of on-line searches, in one embodiment, may permit a user to temporarily disable a selected filter control and re-enable it at a later time. Example method and system to provide in-line refinement of on-line searches may be implemented in the context of a network environment 100 illustrated in FIG. 3 below, specifically as the inline filters application 121.

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, client applications 105 (e.g., mobile applications), an integration module 107, and a web client 106 (e.g., a mobile or desktop Web browser) operating on the client machine 110 (e.g., a mobile device), as well as a programmatic client 108 operating on the client machine 112.

An application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. Shown in FIG. 1 is an inline filters application 121 included as one of the marketplace applications 120. The inline filters application 121 may be utilized beneficially to provide search filtering functionality accessible from within the presentation of an item listing, as described herein.

The payment applications 122 may provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs client-server architecture, the subject matter of the application is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interlace provided by the API server 114. The programmatic client 108 may, for example, be a seller application (e.g., the TurboLister application developed by eBay Inc of San Jose, Calif.) to enable sellers to author and manage listings on the networked system 102 in an off-line manner, and to perform batch-mode communications between the programmatic client 108 and the networked system 102.

The integration module 107 on the client machine (e.g., a mobile phone) may submit requests to the marketplace applications 110, through the API server 114, for an up-to-date (e.g., current) publication related to goods and/or services being offered for sale via the networked system 102. A publication related to goods and/or services being offered for sale may also be termed an item listing. Alternatively or additionally the client machine 110 may request one or more current publications from the client machine 112, via the network 104. In various example embodiments, the client machine 112 may provide a current publication to the client machine 110, after generating the current publication or retrieving such a publication from the networked system 102.

In some example embodiments, the integration module is embedded within one or more of the client applications 105 and may collect user parameters, receive targeted current publications based on the user parameters, and cause the display of one or more targeted current publications. A targeted current publication may be displayed among graphics associated with the application in which the integration module is embedded.

The applications 120, including the inline filters application 121, may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access server one or more databases 126 via the database servers 128.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services.

FIG. 2 is a block diagram of a system 200 to provide in-line refinement of on-line searches, in accordance with one example embodiment. Components of the system 200 may be implemented as hardware, software, or a combination thereof. As shown in FIG. 2, the system 200 comprises a listing access module 202, an attribute selector 204, a filter control generator 206, and a presentation module 208. The listing access module 202 may be configured to access a listing submitted to an on-line trading platform. The attribute selector 204 may be configured to select an attribute in the listing. The filter control generator module 206 may be configured to link the attribute to a search filter. The search filter comprises a search criterion corresponding to the attribute. For example, one of the attributes of a listing may be information about the seller of the listed item. The filter control generator module 206 may link the seller information attribute to a search filter that may be used to determine whether other listings have an attribute that matches that seller's information.

The presentation module 208 may be configured to present the attribute in the listing as a filter control in a presentation of the listing. The presentation module 208 may present the filter control in the listing in a highlighted manner, e.g., in a special font or as a button, etc. The filter control, e.g., a control button or a clickable text, etc., may be actionable to trigger a search request comprising the search criterion corresponding to the attribute. As mentioned above, the presentation of the listing is one of a plurality of search results generated in response to a search request from a user. The search request associated with the filter control (a further search request) comprises parameters of the first search request in addition to the search criterion corresponding to the attribute (in the example above, seller's information).

Also shown in FIG. 2 is a search refinement module 210. The search refinement module 210 may be configured to detect an event associated with the filter control (e.g., a click) and perform a search based on parameters of the first search request and the search criterion corresponding to the attribute associated with the filter control. As mentioned above, a filter control may be temporarily disabled and the re-enabled at a later time. The filter control generator 206 may be configured to disable a search filter in response to a request to disable the search filter. The presentation module 208 may be configured to present a disabled filter control in a manner indicative of the selected attribute being not actionable (e.g., stricken-through, grayed-out, etc.). The presentation module 208 may be configured to present, on the display device, an option to re-enable the filter control. An example method to provide in-line refinement of on-line searches can be described with reference to FIG. 3.

FIG. 3 is a flow chart of a method 300 to provide in-line refinement of on-line searches, according to one example embodiment. The method 300 may be performed by processing logic that may comprise hardware (e.g., dedicated logic, programmable logic, microcode, etc.), software such as run on a general purpose computer system or a dedicated machine), or a combination of both. In one example embodiment, the processing logic resides at the server system 118 of FIG. 1 and, specifically, at the system 200 shown in FIG. 2.

As shown in FIG. 3, the method 300 commences at operation 310, when the listing access module 202 of FIG. 2 accesses a listing submitted to an on-line trading platform. The attribute selector 204 of FIG. 2 selects an attribute in the listing at operation 320. The filter control generator module 206 of FIG. 2 links the attribute to a search filter at operation 330. At operation 340, the presentation module 208 of FIG. 2 presents the attribute in the listing as a filter control in a presentation of the listing.

FIG. 4 shows an example presentation 400 of a listing 410 comprising a niter control, in accordance with an example embodiment. For example, a search for phones in the context of an on-line trading platform may return a number of item listings, as shown in FIG. 4. A user may select an item from the list of results (the presentation 400 comprising the listing 410 and further search results 420) to view the details associated with the listing 410, such as, e.g., the location of the item and the seller's information. As shown in FIG. 4, the seller's information (“SELLER: LotsOfGoodies”) is presented as actionable control that can be activated to further refine search results. Information window 412 may be presented when a pointer hovers over the seller's information area. The information, window 412 explains that the seller information is a filter control. For example, by clicking on the seller's name (“SELLER: LotsOfGoodies”) a user may reduce the search results to only those items that are offered for sale by that seller.

Any of the filters presented as part of the listing detail—also termed inline filters or filter controls—can be temporarily disabled upon a users request, e.g., using a visual control. A temporarily disabled fiber may be presented as stricken-through to indicate that it has been disabled. A user may be permitted to enable a disabled filter, e.g., by clicking on a stricken-through presentation of the filter. A user may be permitted to remove a filter associated with an item listing attribute, e.g., by clicking an associated ‘remove’ control. A ‘remove’ control may be presented, e.g., as the control button 414 located next to the filter presentation in the listing.

In some embodiments, a user is permitted to use inline filters as so-called reverse filters, to reduce the search results only to those Items that do not satisfy the condition expressed by the attribute. For example, referring to FIG. 4, a user may be permitted to search for only those items from the search results that are offered by sellers other than the seller of the selected item (“SELLER: LotsOfGoodies”).

FIG. 5 is a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (CPU) or both, a main Memory 504 and a static memory 506, which communicate with each other via a bus 505. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) arid a network interface device 520.

If The disk drive unit 516 includes to machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-State memories, optical and magnetic media. Such media may also include, without limitation, hand disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, were the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules, in embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers as examples of machines including processors), these operations being accessible via a network (e.g., the Internet) and via one or more appropriate interfaces (e.g., Application Program Interfaces (APIs).)

Thus, method and system to provide in-line refinement of on-line searches have been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A system comprising:
at least one processor coupled to a memory;
a listing access module to access, using at least one processor, a listing submitted to an on-line trading platform;
an attribute selector to select, using at least one processor, an attribute in the listing;
a filter control generator module to link, using at least one processor, the attribute to a search filter comprising a search criterion corresponding to the attribute; and
a presentation module to present, using at least one processor, the attribute as a filter control in a presentation of the listing, the filter control being actionable to trigger a search request comprising the search criterion corresponding to the attribute,
the filter control generator further configured to receive a request to disable the search filter associated with the attribute and disable the search filter.

2. The system of claim 1, wherein the presentation of the listing is one of a plurality of search results, the search results generated in response to a first search request from a user.

3. The system of claim 2, wherein the search request associated with the filter control comprises parameters of the first search request in addition to the search criterion corresponding to the attribute.

4. The system of claim 3, comprising a search refinement module to, using at least one processor:
detect an event associated with the filter control; and
perform a search based on parameters of the first search request and the search criterion corresponding to the attribute.

5. The system of claim 1, wherein the presentation module is to present the filter control in the listing in a highlighted manner.

6. (canceled)

7. The system of claim 6, wherein the presentation module is to present, on the display device, an option to re-enable the filter control.

8. The system of claim 6, wherein the presentation module is to present, on the display device, the selected attribute in the listing in a manner indicative of the selected attribute being not actionable.

9. The system of claim 6, wherein the filter control generator is to:
receive a request to re-enable the search filter associated with the attribute; and
re-enable the search filter.

10. The system of claim 1, wherein the filter control is a reverse filter control, the reverse filter control being actionable to trigger a search request comprising the search criterion corresponding to the attribute, the search criterion being to exclude from search results listings having the selected attribute.

11. A method comprising:
accessing, using at least one processor, a listing submitted to an on-line trading platform;
selecting, using at least one processor, an attribute in the listing;
linking, using at least one processor, the attribute to a search filter comprising a search criterion corresponding to the attribute;
in a presentation of the listing, presenting, using at least one processor, the attribute as a filter control, the filter control being actionable to trigger a search request comprising the search criterion corresponding to the attribute,
receiving a request to disable the search filter associated with the attribute; and
disabling the search filter.

12. The method of claim 11, wherein the presentation of the listing is one of a plurality of search results, the search results generated in response to a first search request from a user.

13. The method of claim 12, wherein the search request associated with the filter control comprises parameters of the first search request in addition to the search criterion corresponding to the attribute.

14. The method of claim 13, comprising:
detecting an event associated with the filter control; and
performing a search based on parameters of the first search request and the search criterion corresponding to the attribute.

15. The method of claim 11, wherein the presenting of the filter control comprises presenting the selected attribute in the listing in a highlighted manner.

16. (canceled)

17. The method of claim 16, comprising presenting, on the display device an option to re-enable the filter control.

18. The method of claim 16, wherein the disabling of the filter control comprises presenting the selected attribute in the listing in a manner indicative of the selected attribute being not actionable.

19. The method of claim 11, wherein the filter control is a reverse filter control, the reverse filter control being actionable to trigger a search request comprising the search criterion corresponding to the attribute, the search criterion being to exclude from search results listings having the selected attribute.

20. A machine-readable non-transitory storage medium having instruction data to cause a machine to:
access a listing submitted to an on-line trading platform;
select an attribute in the listing;
link the attribute to a search filter comprising a search criterion corresponding to the attribute; present the attribute as a filter control in a presentation of the listing, the filter control being actionable to trigger a search request comprising the search criterion corresponding to the attribute,
receive a request to disable the search filter associated with the attribute; and
disable the search filter.
